(19) United States
(12) Patent Application Publication
(10) Pub. No.: US 2012/0027982 A1
(43) Pub. Date: Feb. 2, 2012

(54) POLYURETHANE COMPOSITE MATERIAL AND METHOD FOR FORMING THE SAME

(76) Inventors: CHI-WEN LEE, TAIPEI (TW); TIEN-CHAI KUO, TAIPEI (TW)

(21) Appl. No.: 12/982,684

(22) Filed: Dec. 30, 2010

(30) Foreign Application Priority Data
Jul. 29, 2010 (TW) 099125031

(51) Int. Cl. B32B 3/26; B32B 7/02; B29C 67/20

(52) U.S. Cl. 428/71; 264/46.6; 428/217

(57) ABSTRACT

The present invention provides a polyurethane composite material and a method for forming the same. The method for forming a polyurethane composite material includes the steps of providing a mold; forming a thin layer in the mold, wherein the thin layer has a hardness of shore D 40 to 70; and forming a foaming body covering an additive in the mold, wherein the foaming body is a foamed polyurethane, and the hardness of the thin layer is more than a hardness of the foaming body. There is a thin layer formed on the surface of the polyurethane composite material to avoid formation of pores, decrease the subsequent processing and increase the strength of the product.

### BACKGROUND OF THE INVENTION

1. Field of the Invention

The present invention relates to a polyurethane composite material and a method for forming the same, and more particularly, to a polyurethane composite without pores produced on a surface thereof and with high strength and a method for forming the same.

2. Description of Related Art

A polyurethane (PU) is a polymer formed from diisocyanates and hydroxyl compounds, and used in various applications such as coating materials, automobile accessories, artificial leathers, furniture, and etc. Particularly, polyurethane materials have great thermal insulation and acoustic insulation, and are thus useful in sound barriers and frozen product industries. Upon foam treatment, polyurethane materials are used in a seat cushion, a roof thermal baffle, a compartmented wall, a door plank, and etc.

Generally, a seat cushion is formed by attaching polyvinyl chloride (PVC) leather to an inner surface of a mold by a vacuum pump, and injecting polyurethane foam into the mold. However, the conventional seat cushions are flexible and comfortable but have poor hardness and strength.

The strength of polyurethane foam materials for a door plank is improved by adding an enforcement material. FIG. 4 shows a structure of a conventional polyurethane composite material and a fabrication method thereof. A mold 40 is provided with an enforcement material 45 such as wood blocks, and then injected with foamed PU47, so as to form a polyurethane composite material. The high density of PU is used in the conventional polyurethane composite material for increasing the strength of the polyurethane composite material. However, the resulting PU composite material has pores 48 on the surface thereof which need to be repaired, and thus the production rate is slowed down. Furthermore, even though the pores on the surface of the PU composite material are filled, the quality of the PU composite material cannot be improved.

Therefore, there is a need to develop a polyurethane composite material without pores and a fabrication method thereof for maintaining strength of products, facilitating subsequent processing and increasing production rate.

### SUMMARY OF THE INVENTION

The present invention provides a method for forming a polyurethane composite material, including the steps of: providing a mold; forming a thin layer in the mold, wherein the thin layer has a hardness of shore D 40 to 70; and forming a foaming body covering an implant in the mold, wherein the foaming body is a foamed polyurethane, and the hardness of the thin layer is more than a hardness of the foaming body.

In the method of the present invention, the foaming body is formed by the steps of: providing the implant into the mold having the thin layer therein; and filling the mold with the foamed polyurethane. Alternatively, the implant is premixed with reactants, wherein the reactants are used for preparing the polyurethane; and a foamed polyurethane is formed in the mold. If the implant is premixed with the foamed polyurethane, the implant may be powders or granules.

In the method of the present invention, the thin layer having a thickness of 0.05 to 10 mm is formed by spraying or injecting.

In accordance with the method of the present invention, a polyurethane composite material is provided. The polyurethane composite material includes an implant; a foaming body covering on the implant, wherein the foaming body is a foamed polyurethane; and a thin layer formed on a surface of the foaming body, wherein a hardness of the thin layer if shore D 40-70 and is more than a hardness of the foaming body.

In the polyurethane composite material of the present invention, the implant may be a block, a sheet, powders or granules. Since the polyurethane composite material includes a thin layer and a foaming body, the density of the foamed polyurethane is decreased as 0.05 to 0.9 g/cm³.

The hardness of the foaming body is shore A 70 to 95. In addition, thin layer is made of a polyurethane, a polyurea, or a combination thereof. In the polyurethane composite material of the present invention, the thin layer may be formed on one surface, two opposing surfaces or all surfaces of the foaming body.

Therefore, in the present invention, a harder thin layer formed in the mold is made of polyurethane or polyurea to imitate wood; the foaming body is the foamed polyurethane with lower density, which will not decrease the strength of the final product; and the implant is provided for maintaining and even increasing the strength of the final product. In addition, the thin layer is formed in the mold in advance to avoid pores or cracks formed on the surface of the product.

### BRIEF DESCRIPTION OF THE DRAWINGS

FIGS. 1A to 1C are schematic views showing the polyurethane composite material and the fabrication method thereof according to the present invention, wherein FIG. 1B′ is a three-dimensional view the illustration of FIG. 1B;

FIG. 2 is a schematic view showing the polyurethane composite material according an embodiment of the present invention;

FIG. 3 is a schematic view showing the polyurethane composite material according an embodiment of the present invention; and

FIG. 4 is a schematic view showing the conventional polyurethane composite material and the fabrication method thereof.

### DETAILED DESCRIPTION OF THE PREFERRED EMBODIMENTS

The detailed description of the present invention is illustrated by the following specific examples. Persons skilled in the art can conceive the other advantages and effects of the present invention based on the disclosure contained in the specification of the present invention. Note that the structure and scale shown in drawings are used for illustrating rather than limiting the present invention.

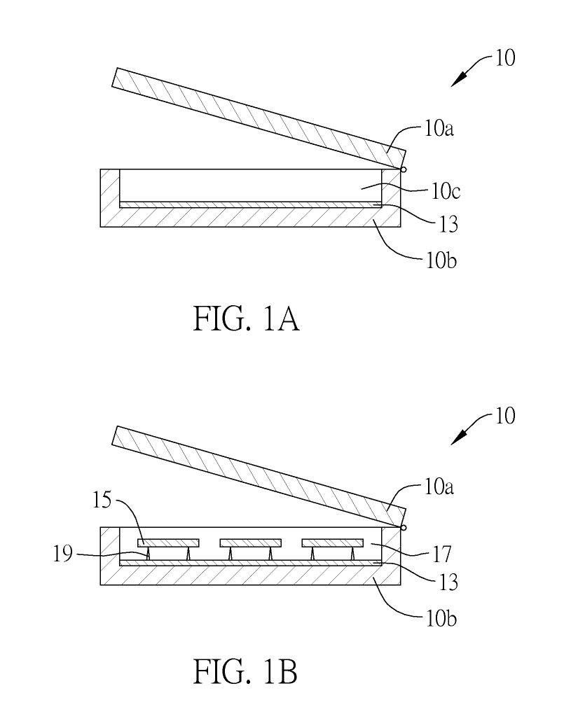

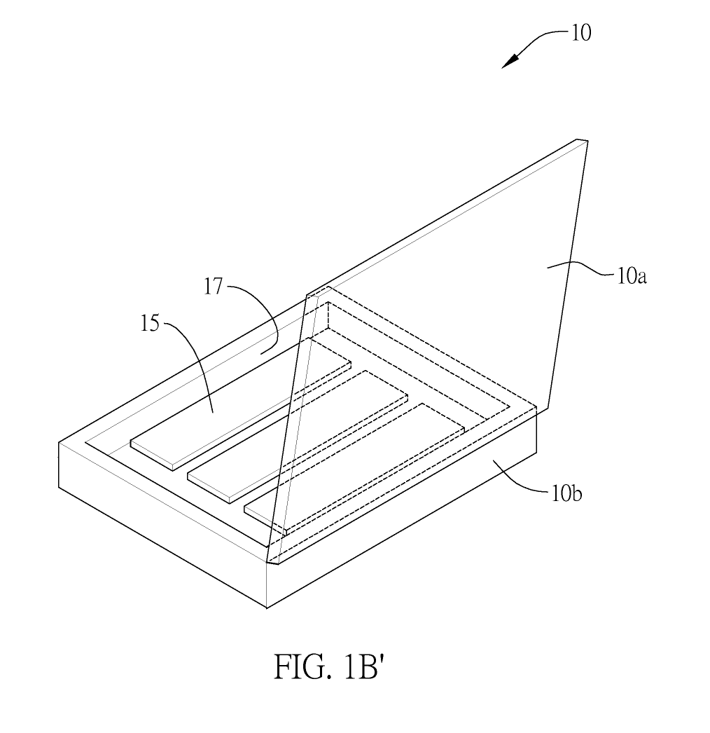

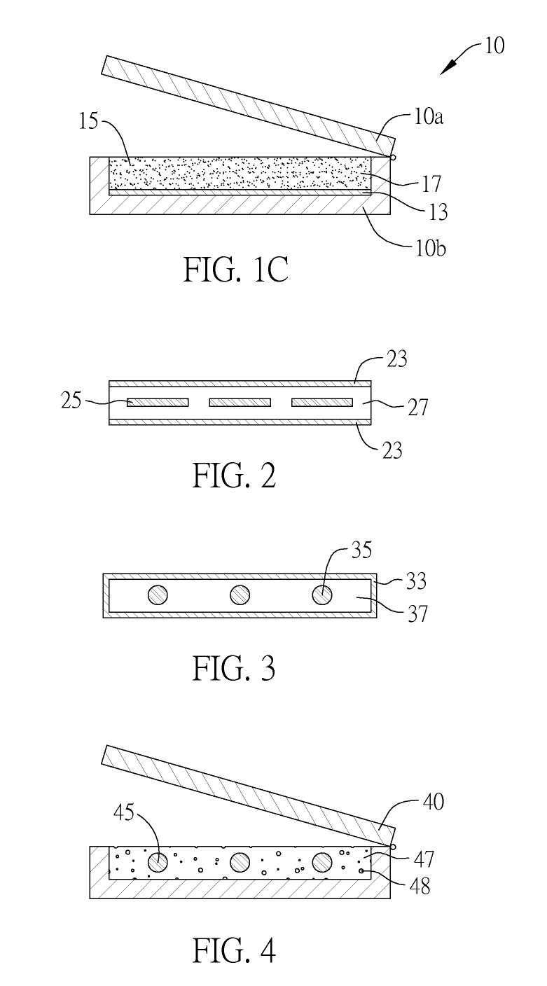

Please refer to FIGS. 1A to 1C showing the method for forming the polyurethane composite material of the present invention.

As shown in FIG. 1A, a mold 10 having an upper mold 10a and a lower mold 10b is provided; and a thin layer 13 is formed in a mold cavity 10c of the mold 10 by spraying or injecting. The thin layer 13 is formed on at least one inner surface of the mold cavity 10c, preferably formed on two opposing inner surfaces of the mold cavity 10c, and more preferably formed on all inner surfaces of the mold cavity 10c. Generally, the surface of the thin layer 13 formed and attached to the previously mentioned at least one inner surface of the mold cavity 10c is the outer surface of the final product for contacting users, and has great appearance and mechanical strength. In addition, the thin layer is made of polyurethane without foaming treatment, and has the hardness of shore D 40 to 70. The thin layer may further include other polymers such as polyurea. Preferably, the hardness of the thin layer is shore D 40 to 70, and the thickness of the thin layer is 0.05 to 10 mm.

As shown in FIG. 1B and FIG. 1B′, after the thin layer 13 is formed in the mold cavity 10c, a foaming body 17 covering implants 15 is formed in the mold cavity 10c, wherein the foaming body 17 is foamed polyurethane and has the hardness of shore A 70 to 95, and wherein the hardness of the thin layer 13 is more than the hardness of the foaming body 17. Further, the hardness of the foaming body 17 is preferably shore A 80 to 95, and more preferably shore A 85 to 95. In this embodiment, after the thin layer 13 is formed in the mold 10, the implants 15 are provided in the mold 10; then the mold 10 is filled with the foamed polyurethane is filled; and the upper mold 10a and the lower mold 10b are sealed, so as to form the polyurethane composite material of the present invention. In this embodiment, there are supporting elements 19 in the mold for accommodating the implants 15 thereon, and then the implants 15 are covered by the foaming body 17. In addition, the implants with larger volume may be blocks or sheets, wherein the types or structures of the implants may be selected optionally. For example, frame type or backbone type of an implant may be used. Moreover, the material of the implant is not limited in the present invention. The implant may be wood, a medium density fiberboard, plastic, a plastic foam plate, a metal, a glass fiber or fire-proofing material such as an asbestos plate. Specifically, the glass fiber may be implanted to avoid over weight, and the metal may be implanted for anti-theft.

In the present invention, the foaming body is hard foamed polyurethane, and is usually formed from the reaction of polyester or polyether, such as polypropylene glycol, and polymeric isocyanates in the presence of a blowing agent such as water, wherein the hard foamed polyurethabe is formed during carbon dioxide production. In addition, the method for forming the foamed polyurethane is not limited to the disclosure of the present invention. Other hard foamed polyurethane may be used in the present invention.

FIG. 1C shows the method for forming another foaming body. If the implants are powders or fine granules, the implants 15 are premixed with the reactants, polyether or polyester, then mixed with polymeric isocyanates, and injected into the mold 10 having the thin layer 13 therein, so as to form the polyurethane foaming body 17.

In the present invention, the density of the foaming body may be decreased as 0.05 to 0.9 g/cm³, preferably as 0.08 to 0.5 g/cm³, and more preferably as 0.1 to 0.3 g/cm³. The polyurethane foaming body with lower density facilitates the filling of mold and decreases the cost of production.

Finally, the foaming body covered by the thin layer is taken out from the mold to obtain the polyurethane composite material of the present invention.

As shown in FIG. 1C, the polyurethane composite material of the present invention includes an implant 15; a foaming body 17 covering the implant 15, wherein the foaming body 17 is hard foamed polyurethane; and a thin layer 13 formed on the surface of the foaming body 17 (herein, on at least surface of the foaming body 17), wherein the hardness of the thin layer 17 is shore D 40 to 70, and the hardness of the thin layer 13 is more than the hardness of the foaming body 17.

In the present invention, the implants are blocks, sheets, powders or granules. The types or structures of the implants may be selected optionally. For example, frame type or backbone type of an implant may be used. Moreover, the material of the implant is not limited in the present invention. The implant may be wood, a medium density fiberboard, plastic, a plastic foam plate, a metal, a glass fiber or fire-proofing material such as an asbestos plate. Specifically, the glass fiber may be implanted to avoid over weight, and the metal may be implanted for anti-theft.

Please refer to FIG. 2 showing the sectional view of the second embodiment of the present invention. The method disclosed in this embodiment is similar to that in the previous embodiment except that the thin layer is formed on the opposing surfaces inside the mold in this embodiment. As shown in FIG. 2, the implants 25 may be formed as those in the previous embodiment, and the thin layer 23 is formed on the two opposing surfaces of the foaming body 27.

Please refer to FIG. 3 showing the sectional view of the third embodiment of the present invention. The method disclosed in this embodiment is similar to that in the previous embodiments except that the thin layer is formed on all surfaces inside the mold in this embodiment. As shown in FIG. 3, the implants 35 may be formed as those in the previous embodiment, and the thin layer 33 is formed on the all surfaces of the foaming body 37.

The polyurethane composite material of the present invention may be used in various fields such as building materials, furniture, accessories, tools, and etc. The building materials may be door planks, compartmented plates, acoustic insulation plates, imitate wood plates, and etc.

In the present invention, a harder thin layer formed in the mold is made of polyurethane or polyurea to imitate wood; and then the foaming body, the foamed polyurethane with lower density, is formed without decreasing the strength of the final product. Further, both the thin layer and the foaming body have polyurethane, such that there is no need to bond the thin layer and the foaming body via an adhesive. In addition, the thin layer is formed in the mold in advance to avoid pores or cracks formed on the surface of the product.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. A method for forming a polyurethane composite material, comprising the steps of:
providing a mold;
forming a thin layer in the mold, wherein the thin layer has a hardness of shore D 40 to 70; and
forming a foaming body covering an additive in the mold, wherein the foaming body is a foamed polyurethane, and the hardness of the thin layer is more than a hardness of the foaming body.

2. The method of claim 1, wherein the foaming body is formed by the steps of:
providing the additive into the mold having the thin layer therein; and
filling the mold with the foamed polyurethane.

3. The method of claim 3, wherein the foaming body is formed by the steps of:
mixing the additive and reactants, wherein the reactants are used for preparing a polyurethane; and
forming the formed polyurethane in the mold having the thin layer therein.

4. The method of claim 3, wherein the additive is a powder or a granule.

5. The method of claim 1, wherein the foaming body has a density of 0.05 to 0.9 g/cm³.

6. The method of claim 1, wherein the hardness of the foaming body is shore A 70 to 95.

7. The method of claim 1, wherein the thin layer is made of a polyurethane, a polyurea or a combination thereof.

8. The method of claim 1, wherein the thin layer has a thickness of 0.05 to 10 mm.

9. The method of claim 1, wherein the additive is a block, a sheet, a powder or a granule.

10. The method of claim 1, wherein the thin layer is formed by spraying or injecting.

11. A polyurethane composite material, comprising:
an additive;
a foaming body covering on the additive, wherein the foaming body is a foamed polyurethane; and
a thin layer formed on a surface of the foaming body, wherein a hardness of the thin layer is shore D 40-70 and is more than a hardness of the foaming body.

12. The polyurethane composite material of claim 11, wherein the additive is a block, a sheet, a powder or a granule.

13. The polyurethane composite material of claim 11, wherein the foaming body has a density of 0.05 to 0.9 g/cm³.

14. The polyurethane composite material of claim 11, wherein the hardness of the foaming body is shore A 70 to 95.

15. The polyurethane composite material of claim 11, wherein the thin layer is made of a polyurethane, a polyurea, or a combination thereof.

16. The polyurethane composite material of claim 11, wherein the thin layer has a thickness of 0.05 to 10 mm.

17. The polyurethane composite material of claim 11, wherein the thin layer is formed on two opposing surfaces of the foaming body.

18. The polyurethane composite material of claim 11, wherein all surfaces of the foaming body are covered with the thin layer.
